(19) United States
(12) Patent Application Publication
(10) Pub. No.: US 2017/0285925 A1
(43) Pub. Date: Oct. 5, 2017

(54) DEVICE AND METHOD FOR GENERATIONAL SOCIAL COMMUNICATION

(71) Applicant: KOREA INSTITUTE OF SCIENCE AND TECHNOLOGY, Seoul (KR)

(72) Inventors: Yong-Moo KWON, Seoul (KR); Rubina Sarki, Seoul (KR); Masooma Zehra Syeda, Seoul (KR); Hayoung JUNG, Seoul (KR)

(73) Assignee: KOREA INSTITUTE OF SCIENCE AND TECHNOLOGY, Seoul (KR)

(21) Appl. No.: 15/471,009

(22) Filed: Mar. 28, 2017

(30) Foreign Application Priority Data
Mar. 29, 2016 (KR) 10-2016-0037476

(51) Int. Cl. G06F 3/0484; G10L 13/08; G10L 15/26; G06F 3/0482

(52) U.S. Cl. CPC G06F 3/04847; G06F 3/0482; G10L 13/08; G10L 15/265

(57) ABSTRACT

Exemplary embodiments relate to a device for generational social communication, including a media contents processor configured to receive media content and additional information associated with the media content from a social network service (SNS) server and display the same on display, a user option provider configured to provide at least one user-selectable option for the media content on the display, and a user option launcher configured to launch a selected user-selectable option when the user-selectable option is selected by a user, and a method for generational social communication using the same.

### CROSS-REFERENCE TO RELATED APPLICATION

This application claims priority to Korean Patent Application No. 10-2016-0037476, filed on Mar. 29, 2016, and all the benefits accruing therefrom under 35 U.S.C. §119, the contents of which in its entirety are herein incorporated by reference.

### BACKGROUND

### 1. Field

The present disclosure relates to a device and method for providing a social network service, and more particularly, to a device and method for generational social communication.

### 2. Description of the Related Art

Recently, smart device usage of old people tends to gradually increase. According to the results of a survey, it is found that old people spend the greatest amount of time in seeing family pictures using smart devices.

However, a social network service (SNS) available on existing smart devices has complicated screen configuration and interface, which is somewhat difficult for old people to use.

For example, old people are unaccustomed to typing, and in using SNS, functions unnecessary for old people other than contents upload and comments upload are all intensively displayed together, making it difficult to access contents.

### RELATED LITERATURES

### Patent Literatures

(Patent Literature 1) US Patent Publication US2010/0036926 A1

### SUMMARY

To solve the problem, the present disclosure is required to provide a device and method for providing a social network service (SNS) that allows old people to use the SNS more easily.

A device for generational social communication according to an embodiment of the present disclosure includes a media contents processor configured to receive media content and additional information associated with the media content from a SNS server and display the same on display, a user option provider configured to provide at least one user-selectable option for the media content on the display, and a user option launcher configured to launch a selected user-selectable option when the user-selectable option is selected by a user.

In an embodiment, the user option launcher may be configured to add additional information associated with the media content based on user input information inputted according to the selected user-selectable option, or add new media contents to the SNS server.

In an embodiment, the additional information may include at least one of uploader information, comments, and emotion expression.

In an embodiment, the media contents processor may be configured to display only user information, the media content, and the additional information on the display.

In an embodiment, the user-selectable option may include at least one of reproduce comments, write comments, express emotions, and upload media contents.

In an embodiment, the user option provider may be configured to display each user-selectable option as number.

In an embodiment, the user option provider may be configured to provide voice guidance for receiving user input for the selected user-selectable option.

In an embodiment, the user option launcher may be configured to convert inputted user input information by speech-text conversion to generate the user input information in the form of voice and/or text, when write comments or commenting is selected by the user and the user input information is inputted as voice.

In an embodiment, the user option launcher may be configured to output a comment selected by the user as voice by text-speech conversion.

A method for generational social communication according to an embodiment of the present disclosure includes receiving media content and additional information associated with the media content from a SNS server and displaying the same on display, providing at least one user-selectable option for the media content on the display, and launching a selected user-selectable option when the user-selectable option is selected by a user.

In an embodiment, the launching of a user-selectable option may include adding additional information associated with the media content based on user input information inputted according to the selected user-selectable option, or adding new media contents to the SNS server.

In an embodiment, the additional information may include at least one of publisher information, comments, and emotion expression.

In an embodiment, the displaying of the media content and the additional information associated with the media content may include displaying only user information, the media content, and the additional information on the display.

In an embodiment, the user-selectable option may include at least one of reproduce comments, write comments, express emotions, and upload media contents.

In an embodiment, the providing of a user-selectable option may include displaying each user-selectable option as number.

In an embodiment, the providing of a user-selectable option may include providing voice guidance for receiving user input for the selected user-selectable option.

In an embodiment, the launching of a user-selectable option may include converting inputted user input information by speech-text conversion to generate the user input information in the form of voice and/or text, when write comments or commenting is selected by the user and the user input information is inputted as voice.

In an embodiment, the launching of a user-selectable option may include outputting a comment selected by the user as voice by text-speech conversion.

A computer-readable recording medium according to an embodiment of the present disclosure may store instructions for performing the method.

According to an embodiment of the present disclosure, an advantage is that old people can use SNS easily through a voice-based interface, resulting in smooth communication between generations and reduced generation gaps.

### BRIEF DESCRIPTION OF THE DRAWINGS

FIG. 1 shows a computer environment in which a device for generational social communication according to an embodiment of the present disclosure operates.

FIG. 2 is a block diagram of the device 10 for generational social communication according to an embodiment of the present disclosure.

FIG. 3 is an example of media content and additional information displayed by the device 10 for generational social communication.

FIG. 4 is an example of a media content area 120 according to an embodiment.

FIG. 5 is a diagram for illustrating an example of comment input.

FIG. 6 shows an example of a user interface input device according to an embodiment of the present disclosure.

FIG. 7 is a flowchart of a method for generational social communication according to an embodiment of the present disclosure.

### DETAILED DESCRIPTION

The terminology used herein is for the purpose of describing particular embodiments only and is not intended to limit the present disclosure. As used herein, singular forms are intended to include plural forms as well, unless the context clearly indicates otherwise. It should be understood that the terms “comprises” and/or “comprising”, or “includes” and/or “including” when used in this specification, specify the presence of stated features, integers, steps, operations, elements, components or groups thereof, but do not preclude the presence or addition of one or more other features, integers, steps, operations, elements, components, or groups thereof.

Unless otherwise defined, all terms (including technical and scientific terms) used herein have the same meaning as commonly understood by those skilled in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. In the drawings, like reference numerals denote like elements.

Rather, in describing the embodiments, when a certain detailed description of related known functions or elements is deemed as unnecessarily rendering the essence of the present disclosure ambiguous, their detailed description is omitted herein. In addition, the size of each element in the drawings may be exaggerated for clarity, and does not represent the actually used size.

The embodiments described herein may take the form of entirely hardware, partially hardware and partially software, or entirely software. The term “unit”, “module” “device”, or “system” as used herein indicates a computer-related entity such as hardware, a combination of hardware and software, or software. For example, a unit, module, device or system used herein may include, but is not limited to, a process being executed, a processor, an object, an executable, a thread of execution, a program, and/or a computer. For example, both a computer and an application running on the computer may correspond to the term unit, module, device, or system used herein.

The embodiments have been described with reference to the flowchart presented in the drawings. For the sake of simplicity, although the method has been illustrated and described as a series of blocks, the present disclosure is not limited to the order of the blocks, and some of the blocks may be placed with the other blocks in a different order from an order illustrated and described herein or may be concurrent with the other blocks, and a variety of other diverges, flow paths, and block sequences that achieve same or similar results may also be implemented. Furthermore, all the illustrated blocks may not be required to implement the method described in the specification. Further, the method according to an embodiment of the present disclosure may be implemented in the form of a computer program for performing a series of processes, and the computer program may be recorded on a computer-readable recording medium.

Hereinafter, the embodiments of the present disclosure will be described in detail with the reference to the accompanying drawings. Rather, in describing the embodiments, when a certain detailed description of related known functions or elements is deemed as unnecessarily rendering the essence of the present disclosure ambiguous, their detailed description is omitted herein. In addition, the size of each element in the drawings may be exaggerated for clarity, and does not represent the actually used size.

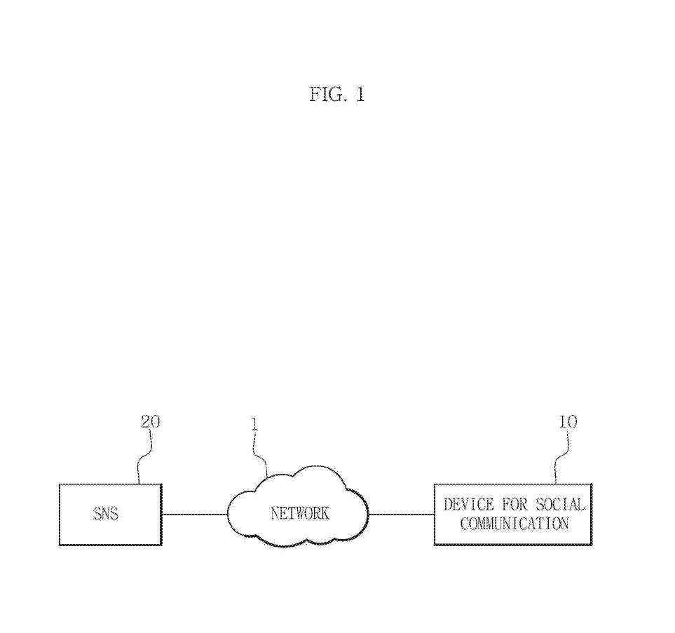

FIG. 1 shows a computer environment in which a device for generational social communication according to an embodiment of the present disclosure operates. As shown in FIG. 1, the computer environment includes a social network service (SNS) server 20 and a client 10 communicatively connected via a network 1. For concise and clear description of embodiments, only one of entities is shown. That is, more other entities such as a web server may exist in the computer environment.

The SNS server 20 is a hardware device and/or a software program, and is configured to provide a social network service to the client 10 or other system. The social network service includes services that store, share, and display various types of media contents uploaded to the SNS server 20 by service users, to provide the same to other service users.

The SNS server 20 and the client 10 may be synchronized with each other. Accordingly, media contents uploaded to the SNS server may be provided to the client, and media contents uploaded to the client may be provided to the SNS server. For this end, the client 10 may use a predetermined application programming interface (API) of the SNS server 20.

The SNS server 20 may be one of an online community server, a SNS providing server, and a blog service providing server. For example, the SNS server 20 may include FACEBOOK®, CYWORLD®, GOOGLE®, DAUM®, NAVER®. FLICKR®, TWITTER®, LINKNOW®, WEEBLY®, TODOLY®, RAINMAKER®, SEESMIC®, SLIDEROCKET®, LINKEDIN®, and PINTEREST®. Furthermore, in an embodiment, the SNS server 20 may include homepages of registered friends, and webpages such as Timeline or Wall of FACEBOOK®.

Furthermore, in an embodiment of the present disclosure, the media contents may be multimedia contents including at least one of image, video, audio, text, and voice.

The client 10 is a computer system, and the client 10 may be a smart phone, a desktop computer, a laptop computer, a digital camera, any wearable digital device, a personal digital assistant (PDA), a server, or a tablet PC. Hereinafter, the client 10 is referred to as a device for generational social communication.

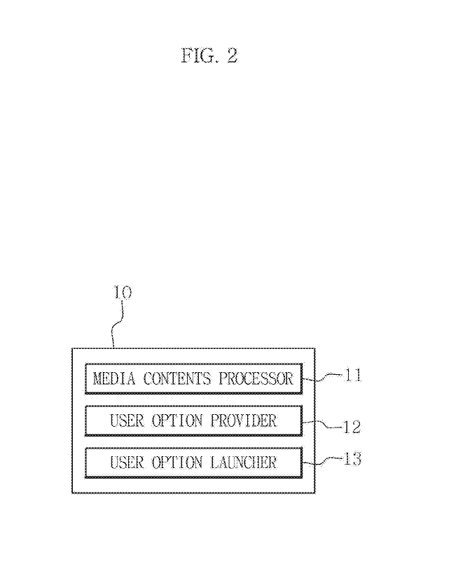

FIG. 2 is a block diagram of the device 10 for generational social communication according to an embodiment of the present disclosure. Referring to FIG. 2, the device 10 for generational social communication includes a media contents processor 11, a user option provider 12, and a user option launcher 13.

When a user sets at least one SNS account and logs in, the media contents processor 11 accesses the SNS server 20 corresponding to each SNS account, searches for media contents, and downloads new media contents. That is, the media contents processor 11 determines if there is any new media content not uploaded when logging in before, and if so, receives (downloads) it. For example, the media contents processor 11 receives media contents and additional information associated with the media contents from each SNS server 20. Subsequently, the media contents processor 11 displays the received media contents and additional information associated with the media contents on the display. That is, the media contents processor 11 gathers new media contents received from at least one SNS server and displays them on a single display. The new media contents displayed on the display may be arranged in chronological order or according to the type of SNS.

Accordingly, the user logs in to the SNS server 20 through the media contents processor 11, and can use media contents provided by the SNS server 20 and their additional information.

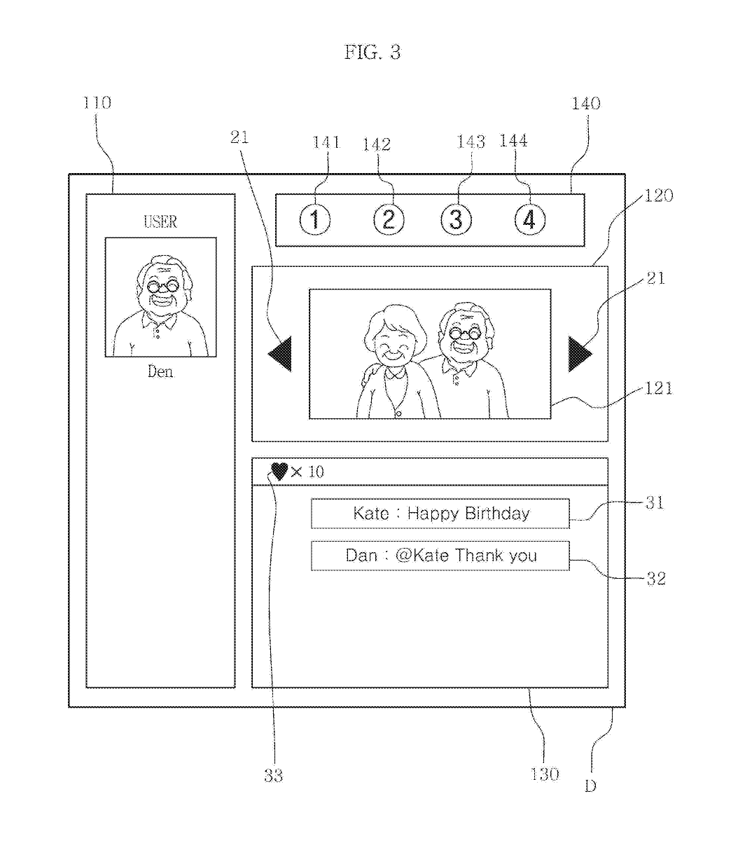

FIG. 3 is an example of media content and additional information displayed by the device 10 for generational social communication. In FIG. 3, the display D is divided into a plurality of areas. Each area may be generated and managed by the media contents processor 11.

Referring to FIG. 3, the media contents processor 11 may generate a user information area 110, a media content area 120, an additional information area 130, and a user option area 140 on the display.

The user information area 110 displays information of a user who logged in to SNS of the SNS server 20 through the device 10 for generational social communication. Referring to FIG. 3, it is displayed that the user called Den logged in.

The media content area 120 displays media content received from the SNS server 20. The user can view other media contents using a move icon 21.

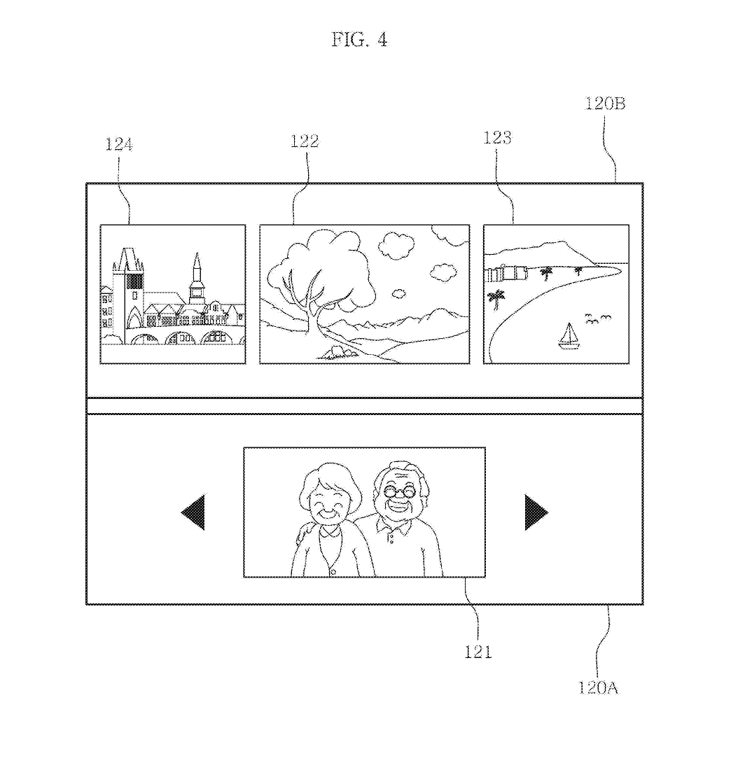

FIG. 4 is an example of the media content area 120 according to an embodiment. The media content area 120 may be divided into a plurality of areas 120A and 120B. One area 120A may display media content 121 of additional information being currently displayed, and the other area 120B may display media contents 122-124 that the media contents processor 11 can provide. The user can select any one of the media contents 122-124 and view additional information associated with the corresponding media content.

The additional information area 130 may display additional information associated with the media content 121 being currently displayed on the media content area 120. The additional information may include publisher information, comments and emotion expression. The publisher may include a friend on SNS who uploaded the corresponding media content to the SNS server 20 or shared the media content.

Referring to FIG. 3, comments 31 and 32 inputted by kate and den are being displayed. Furthermore, emotion expression 33 about the media content 121 is also displayed. The emotion expression may include Like of Facebook. The additional information displayed on the additional information area 120 comes from additional information (reply, emotional information, and publisher information) inputted to the SNS server 20.

In an example, the media contents processor 11 may display only user information, media contents, and additional information on the display D. The commonly used SNS service providing screen displays very various types of information. For example, groups for which a logged in user has signed up, ads, recommended pages, recommended friends, apps, interests, and bookmarks are displayed on web pages. Accordingly, the media contents processor 11 may display only items relating to media contents except the above items. As only user information, media contents, and additional information absolutely necessary for the user to use SNS are displayed on the display, the user can use the SNS more easily.

The user option provider 12 may provide at least one user-selectable option for the media content on the display D. The user-selectable option may be displayed on the user option area 140.

The user-selectable option may include, but is not limited to, reproduce comments, write comments, express emotions, and upload media contents. The user may select a comment displayed on the additional information area or an author of the comment, and write an additional comment to the corresponding comment. The prepared comment may be posted on SNS related to the corresponding media content.

By way of illustration for clarity of description in this specification, in user-selectable options 141-144 of FIG. 3, \textcircled{1} 141 represents express emotions, \textcircled{2} 142 represents write comments, \textcircled{3} 143 represents reproduce comments, and \textcircled{4} 144 represents upload media contents.

The user may select a user-selectable option by touching the screen, or using a mouse cursor on the screen, a voice interface, or a remote control with number buttons. For example, as shown in FIG. 3, the user option provider 12 may display each user-selectable option as number.

In other embodiments, the user option provider 12 may provide voice guidance for receiving user input of the selected user-selectable option.

When a user-selectable option is selected by the user, the user option launcher 13 may launch the selected user-selectable option. The user option launcher 13 may add additional information associated with the media content based on user input information inputted according to the selected user-selectable option, or may add new media contents to the SNS server. For example, the user may designate a specific person who left a comment, and leave a comment for the designated specific person. The comment may be a voice or text.

Accordingly, the user (for example, a senior citizen) unaccustomed to complicated SNS service screen configuration can use the SNS service through the device 10 for generational social communication that provides a relatively simple screen configuration and supports a voice interface.

Referring to FIG. 3, when the user selects \textcircled{1} express emotions 141, the user option launcher 13 may ask “Do you like corresponding media content” through a popup window or voice guidance, and change emotional information about the corresponding media content in response to the user reaction. That is, when the user answers “yes”, one heart may be added. Information about the number of hearts added may be immediately transmitted to the SNS server 20.

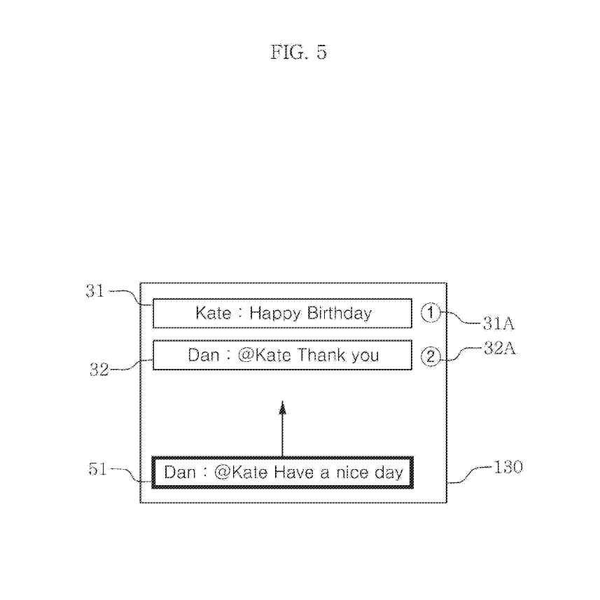

FIG. 5 is a diagram for illustrating an example of comment input. Referring to FIGS. 3 and 5, when the user selects \textcircled{2} write comments 142, the user option launcher 13 may request comment input through a popup window or voice guidance. The user option launcher 13 may generate a comment input window 51, and display user input information inputted by the user on the comment input window 51. For example, when the user inputs a comment (user input information) with his/her voice, the user option launcher 13 may input text and voice using text to speech (TTS) and speech to text (STT) functions. Referring to FIG. 5, the comment input window 51 on which Den leaves a comment have a nice day for kate is displayed. When input is completed, the inputted comment is added to the comment area 130 of additional information.

Furthermore, when the user selects \textcircled{3} reproduce comments 143, as shown in FIG. 5, the user option provider 12 may display numbers 31A and 31B for each comment. In this case, the user may select each comment by inputting the corresponding numbers. When a comment is selected, the user option launcher 13 may output the selected comment as voice. For voice output, the user option launcher 13 may use a TTS function.

In other example, a question ‘which number comment do you want?’ is asked through voice guidance, and in response to the user's answer (for example, No. 2), the corresponding comment may be outputted as voice.

Furthermore, when the user selects upload media contents \textcircled{4} 144, media content upload may be requested through a popup window or voice guidance, and in response to the user input, media contents may be uploaded. For example, when the user speaks a specific sentence, the user option launcher 13 may convert the sentence spoken by the user into text and upload it to the device 10 for generational social communication. The uploaded text (i.e., media content) may be synchronized with the SNS server 20.

That is, when write comments or commenting is selected by the user and user input information is inputted as voice, the user option launcher 13 may convert the inputted user input information by speech-text conversion to generate the user input information in the form of voice and/or text. Furthermore, in the same way, the user option launcher 13 may output the comment selected by the user as voice by text-speech conversion.

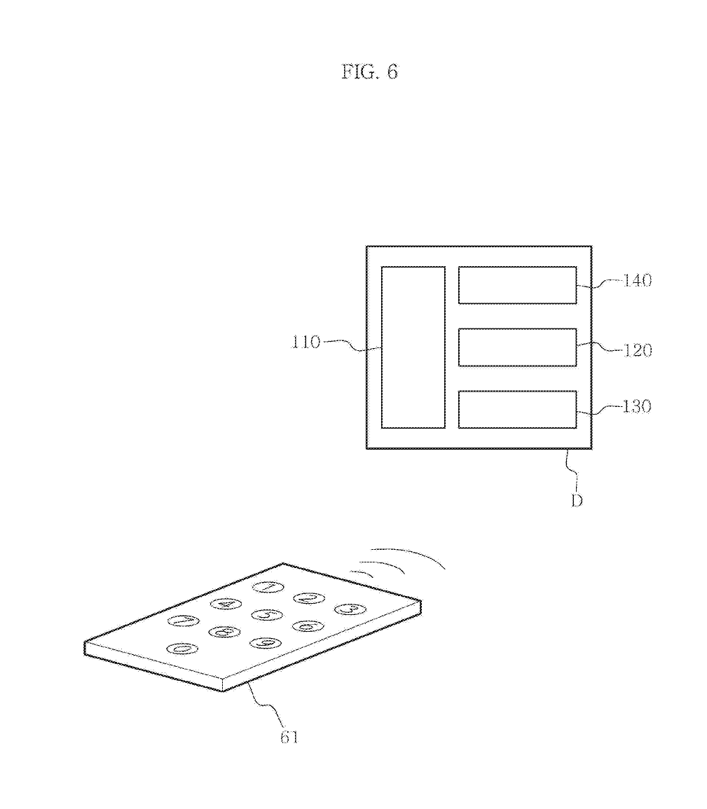

FIG. 6 shows an example of a user interface input device according to an embodiment of the present disclosure. In an example, the user may use the device 10 for generational social communication through a remote controller 61 and/or a voice. The user option provider 12 may display a user option that can be selected by the user as number, allowing the user to select a user option using the number keys of the remote control. Furthermore, the user option may be provided through voice, and user information input according to the selected user option may be also guided through voice, allowing the user to express the user's desired content as voice alone. The user option launcher 13 may convert the inputted voice information of the user into text, and the media content (or comment) composed of text information and voice information together may be uploaded to the SNS server 20. Accordingly, the media content (or comment) composed of text information and voice information uploaded by the user may be outputted as text or voice by selection of another user.

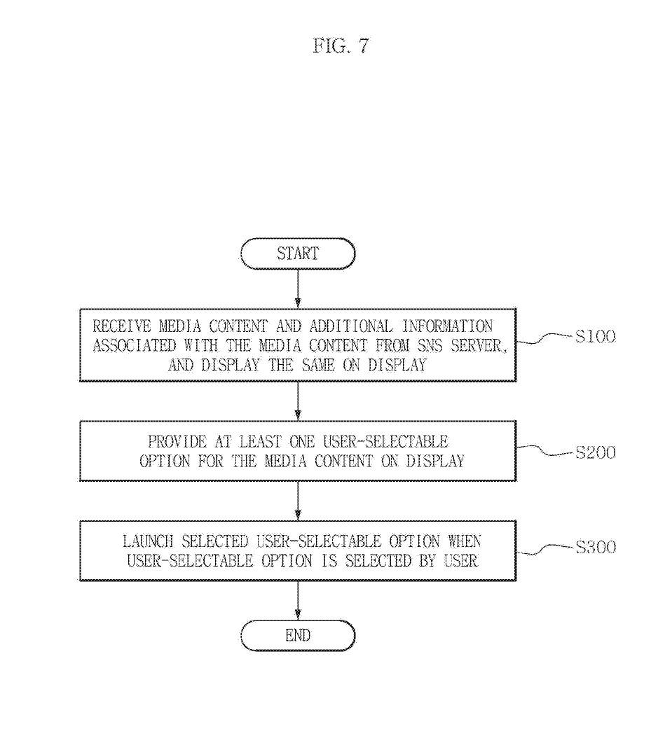

FIG. 7 is a flowchart of a method for generational social communication according to an embodiment of the present disclosure. The method for generational social communication may be implemented by the elements of the device for generational social communication.

The method for generational social communication includes receiving media content and additional information associated with the media content from a SNS server, and displaying the same on the display (S100), providing at least one user-selectable option for the media content on the display (S200), and launching a selected user-selectable option when the user-selectable option is selected by a user (S300).

Here, the additional information may include at least one of publisher information, comments, and emotion expression. Furthermore, the user-selectable option may include at least one of reproduce comments, write comments, express emotions, and upload media contents.

The launching of a user-selectable option (S300) may include adding additional information associated with the media content based on user input information inputted according to the selected user-selectable option, or adding new media contents to the SNS server.

Furthermore, in an embodiment, the step S100 may include displaying only user information, the media content, and the additional information on the display.

The providing of a user-selectable option (S200) may include providing voice guidance for receiving user input for the selected user-selectable option, or displaying each user-selectable option as number.

The launching of a user-selectable option (S300) may include converting inputted user input information by speech-text conversion to generate the user input information in the form of voice and/or text, when write comments or commenting is selected by the user and the user input information is inputted as voice.

Furthermore, the launching of a user-selectable option (S300) may include outputting a comment selected by the user as voice by text-speech conversion.

A computer-enabled recording medium according to an embodiment of the present disclosure may store a program made of instructions for performing the method for generational social communication.

Furthermore, the program according to an embodiment of the present disclosure may be made of instructions for performing the method for generational social communication, and may be implemented in combination with hardware.

While the present disclosure has been hereinabove described with the embodiments shown in the drawings, this is provided for illustration only and it will be understood by those skilled in the art that various changes in form and details may be made thereto. However, it is intended that such changes fall within the technical scope of protection of the present disclosure. Therefore, the true technical scope of the protection of the present disclosure shall be defined by the technical spirit of the appended claims.

What is claimed is:

1. A device for generational social communication, comprising:
a media contents processor configured to receive media content and additional information associated with the media content from a social network service (SNS) server, and display the same on display;
a user option provider configured to provide at least one user-selectable option for the media content on the display; and
a user option launcher configured to launch a selected user-selectable option when the user-selectable option is selected by a user.

2. The device for generational social communication according to claim 1, wherein the user option launcher is configured to add additional information associated with the media content based on user input information inputted according to the selected user-selectable option, or add new media contents to the SNS server.

3. The device for generational social communication according to claim 1, wherein the additional information includes at least one of uploader information, comments, and emotion expression.

4. The device for generational social communication according to claim 1, wherein the media contents processor is configured to display only user information, the media content, and the additional information on the display.

5. The device for generational social communication according to claim 4, wherein the user-selectable option includes at least one of reproduce comments, write comments, express emotions, and upload media contents.

6. The device for generational social communication according to claim 4, wherein the user option provider is configured to display each user-selectable option as number.

7. The device for generational social communication according to claim 4, wherein the user option provider is configured to provide voice guidance for receiving user input for the selected user-selectable option.

8. The device for generational social communication according to claim 7, wherein the user option launcher is configured to convert inputted user input information by speech-text conversion to generate the user input information in the form of voice and/or text, when write comments or commenting is selected by the user and the user input information is inputted as voice.

9. The device for generational social communication according to claim 1, wherein the user option launcher is configured to output a comment selected by the user as voice by text-speech conversion.

10. A method for generational social communication, comprising:
receiving media content and additional information associated with the media content from a social network service (SNS) server, and displaying the same on display;
providing at least one user-selectable option for the media content on the display; and
launching a selected user-selectable option when the user-selectable option is selected by a user.

11. The method for generational social communication according to claim 10, wherein the launching of a user-selectable option comprises adding additional information associated with the media content based on user input information inputted according to the selected user-selectable option, or adding new media contents to the SNS server.

12. The method for generational social communication according to claim 10, wherein the additional information includes at least one of publisher information, comments, and emotion expression.

13. The method for generational social communication according to claim 10, wherein the displaying of the media content and the additional information associated with the media content comprises displaying only user information, the media content, and the additional information on the display.

14. The method for generational social communication according to claim 13, wherein the user-selectable option includes at least one of reproduce comments, write comments, express emotions, and upload media contents.

15. The method for generational social communication according to claim 13, wherein the providing of a user-selectable option comprises displaying each user-selectable option as number.

16. The method for generational social communication according to claim 13, wherein the providing of a user-selectable option comprises providing voice guidance for receiving user input for the selected user-selectable option.

17. The method for generational social communication according to claim 16, wherein the launching of a user-selectable option comprises converting inputted user input information by speech-text conversion to generate the user input information in the form of voice and/or text, when write comments or commenting is selected by the user and the user input information is inputted as voice.

18. The method for generational social communication according to claim 10, wherein the launching of a user-selectable option comprises outputting a comment selected by the user as voice by text-speech conversion.

19. A computer-readable recording medium having instructions for performing the method according to claim 10 stored thereon.
